(19) United States
(12) Patent Application Publication
(10) Pub. No.: US 2005/0194079 A1
(43) Pub. Date: Sep. 8, 2005

(54) Easy maintenance automatic tire inflation system

(75) Inventor: Mark K. Hennig, Corpus Christi, TX (US)

Correspondence Address: FULBRIGHT & JAWORSKI, LLP, 1301 MCKINNEY, SUITE 5100, HOUSTON, TX, 77010-3095, US

(73) Assignee: EQUALAIRE SYSTEMS, INC.

(21) Appl. No.: 10/797,745

(22) Filed: Mar. 8, 2004

(51) Int. Cl. B60B 27/00

(52) U.S. Cl. 152/417

(57) ABSTRACT

An automatic tire inflation system in which air for rotating tires is transmitted through an air connection between an air supply and each of the tires. In particularly, the present invention is directed to a hubcap structure housing a removable plug which provides a simple way to check or replenish the lubricant in the hubcap and allows maintenance or replacing of the wear parts in the rotary air connection without disassembling the tire inflation system.

### BACKGROUND OF THE INVENTION

The present invention is directed to improvements in an automatic tire inflation system in which the air for rotating tires is transmitted through an air connection between an air supply and each of the tires. In particularly, the present invention is directed to a hubcap structure which provides a simple way to check or replenish the lubricant in the hubcap and allows maintenance or replacing of the wear parts in the rotary air connection without disassembling the tire inflation system.

The wheel assembly on a truck trailer requires a hubcap at the end of the assembly to retain lubrication in the hubcap compartment for lubricating the wheel bearings as best seen in U.S. Pat. No. 5,584,949. When the vehicle includes an automatic tire inflation system, which may have a pressure of 110 psi, an air leak in the connection system, which passes through the hubcap compartment, can blow out a conventional air vent plug resulting in the loss of lubricant from the wheel bearings and their consequential failure and expensive damage. While the system of the '949 patent is satisfactory for checking and replenishing the lubricant in the hubcap compartment, any repair on the pneumatic rotary union requires removal of the hubcap as the air lines extend through the sides of the hub cap. This requires disconnection of the air lines, is time-consuming, requires tools, and some expertise.

Another prior art system, which will be described in greater detail later, is illustrated in FIG. 1 in which the air connection screws into the center of the hubcap and supports one end of the rotor or rotating member of the pneumatic rotary union. While the air connection or through tee fitting can be removed, it requires disconnection of the air hoses leading therefrom to the tires. In addition, the opening for the tee is not sufficient for satisfactorily adding and inspecting lubricant in the hubcap and therefore a side seal plug is required in the hubcap. This requires additional tools and requires that the rotation of the wheel is positioned so that the wheel plug is upright for filling. This fill method requires tools and does not allow for checking lubrication levels.

### BRIEF SUMMARY OF THE INVENTION

The present invention is directed to a an easy maintenance automatic tire inflation system in which the lubricant in the hubcap may be checked or replenished through a removable center plug in the hubcap without the use of tools. In addition, both the stator and rotor, the stationary and rotating parts of the pneumatic rotary union, can be removed and repaired without disconnecting the hubcap. Furthermore, the structure of the hub is designed to direct lubricant away from the air vents which are positioned in the plug.

One object of the present invention is the improvement of an improved air inflation system having a pneumatic rotary union including a first stationary part and a second rotatable part. A hubcap is provided having an opening coaxially aligned with the rotary union, a plug is releasably supported in the opening, said plug including a support opening coaxially aligned with the rotary union, said plug including one or more air vents positioned outside of the support opening, and said support opening supporting a through tee and a vent shield covering the outside of the air vents supporting one end of the rotatable part of the rotary union. The hubcap opening is of a size for adding and visually inspecting lubrication level and for removing both the rotor and stator of the rotary union through the hubcap opening without removing the hubcap.

A still further object of the present invention is wherein the plug consists of a rigid material for providing a firm support for the through tee, and said plug includes a head at one end for abutting the outside of the hubcap, and an extension extending through and beyond the inside of the hubcap opening and terminating in a second end spaced from the hubcap for diverting lubricant away from the air vents, and a circular seal surrounding the plug intermediate the first and second ends sealing against the inside of the hubcap, and releasably holding the hubcap in position in the hubcap opening.

Yet a still further object of the present invention is wherein the plug includes surfaces exposed to the interior of the hubcap and the surfaces are positioned to direct lubrication in the hubcap away from the air vents.

A still further object is wherein the surfaces include an interior surface outside of the air vents, said interior surface tapering outwardly towards the second end of the plug for centrifugally directing lubrication away from the air vents while the hubcap is rotating. In the preferred embodiment the interior surface includes a first and a second outwardly directed tapered surfaces.

Another object of the present invention wherein the plug includes an exterior surface adjacent the second end of the plug which includes a recess around the exterior surface of the plug for directing lubrication away from the air vents while the hub cap is static.

A further object is wherein the outside of the head of the plug includes a knurled surface for ease of removing the plug from the hubcap opening.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated that the conception and specific embodiment disclosed may be readily utilized as a basis for modifying or designing other structures for carrying out the same purposes of the present invention. It should also be realized that such equivalent constructions do not depart from the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawings, in which:

FIG. 1 is an elevational view, in cross section, of a prior art rotary air connection in a tire inflation system;

FIG. 2 is an elevational view, in cross section, of the present invention;

FIG. 3 is an enlarged elevational view, in cross section, of the removable or popout plug of the present invention;

FIG. 4 is an elevational end view of the plug of FIG. 3; and

FIG. 5 is an exploded perspective view of the present invention.

### DETAILED DESCRIPTION OF THE INVENTION

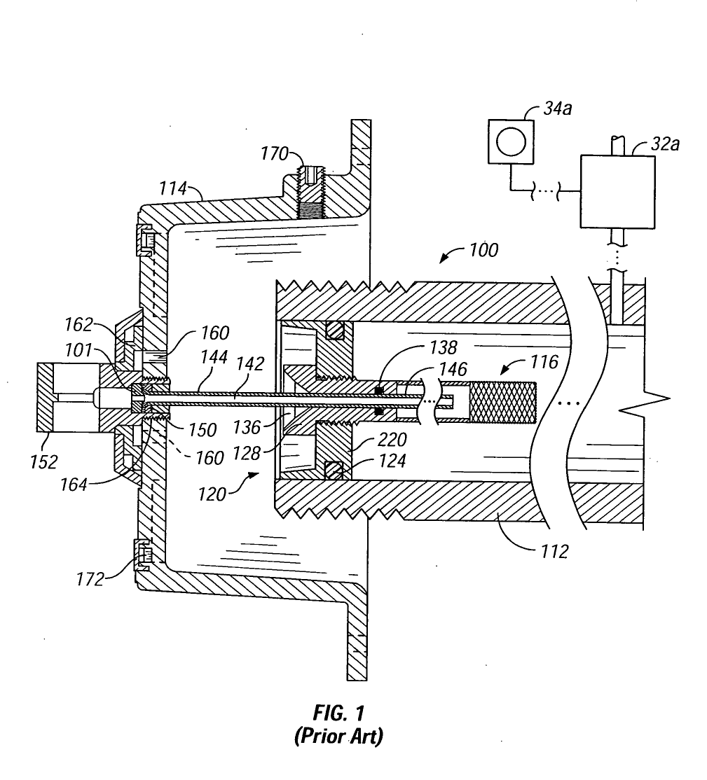

Referring to FIG. 1, a prior art automatic tire inflation system known as MTIS system manufactured by Pressure Systems International of San Antonio, Tex., is shown. The reference numeral 100 generally indicates the rotary air connection for supplying air from an air supply on a vehicle in an automatic tire inflation system for a vehicle to rotating tires. The numeral 112 generally indicates one axle or spindle, a hubcap 114 is provided at each end of the axle 112 for retaining lubricant in the wheel bearings, and an air supply 116 either directly in the axle 112 or through an interior conduit (not shown) in the inside of the axle 112 supplies air to the rotary air connection through the inside of the axle. A pneumatic rotary union generally indicated by the reference numeral 120 is supported and positioned in the center of the axle 112, such as by force fit plug 220, but sealingly engages the interior of the axle 112 by seal 124 as air is injected directly into the inside of the axle 112. The rotary union 120 has a first stationary part or stator 128 having a passageway 136 therethrough. The passageway 136 is in communication with the air supply 116. A first resilient rotary seal 138 is supported in the passageway 136 and encircles the passageway 136. The union 120 includes a second rotatable part or rotor including a tubular member 142 having a first end 144 and a second end 146. The second end 146 is coaxially extendible through and is longitudinally and rotationally movable in the passageway 136 and sealably engages the rotary seal 138 and is in communication with the air supply 116. The first end 144 of the tubular member 142 is sealably connected to the air connection or through tee 152 on the hubcap 114 through a seal 150. The air connection 152 or through tee is provided on the hubcap 114 for connection to the tire or tires through air hoses (not shown) at the end of the axle 112. The end 144 of the tubular member 142 includes a shoulder which includes a bearing 101. In operation, air is supplied through the stationary part 128 of the rotary union 120, through the rotatable member 142, the through tee 152 and to the tires. The system 100 includes the air pressure supply 116 and a suitable warning system such as a flow switch 32a and a warning indicator light 34a in the event of loss of air pressure. The hub cap 114 also includes a plurality of air vent holes 160 and a yieldable rubber vent shield 162 normally closing the vents 160 but opening and allowing the escape of air in the event of a leak from the system 100 into the inside compartment of the hubcap 114. The shield 162 is supported from the through tee 152 which is threadably secured by threads 164 to the wall of the hubcap 114 and supports one end of the rotatable member or rotor 142. Lubrication to the inside of the hubcap 114 is accomplished by a side fill plug 170 on the outer diameter of the hubcap 114. This fill method requires tools for unscrewing the plug 170 and does not allow for checking lubrication levels. While hubcap 114 includes a sight glass 172, it is usually caked up with lubricant and is not usable. In addition, if the position of the truck is such that the plug 170 is not an up position, then the vehicle will have to be rotated to bring the plug 170 into an up position for replenishing the lubricant supply. On a plurality of tires on a vehicle, this can be time-consuming. The through tee 152 can be unscrewed from the hubcap 114, after disconnecting air hoses to the tires (not shown) and remove the rotor 142 for repair. However, the stationary part or stator 128 cannot be removed without removing the hubcap 114.

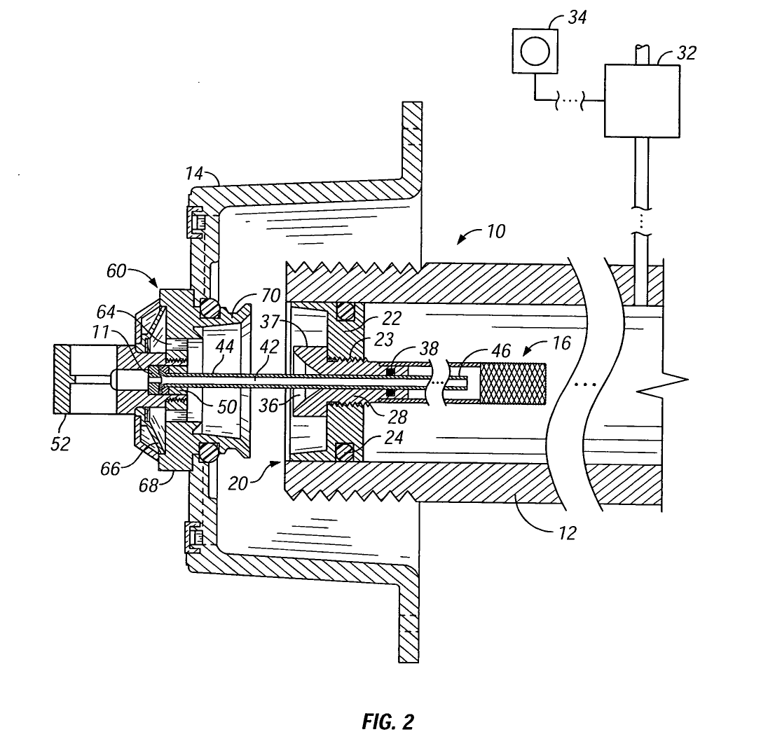

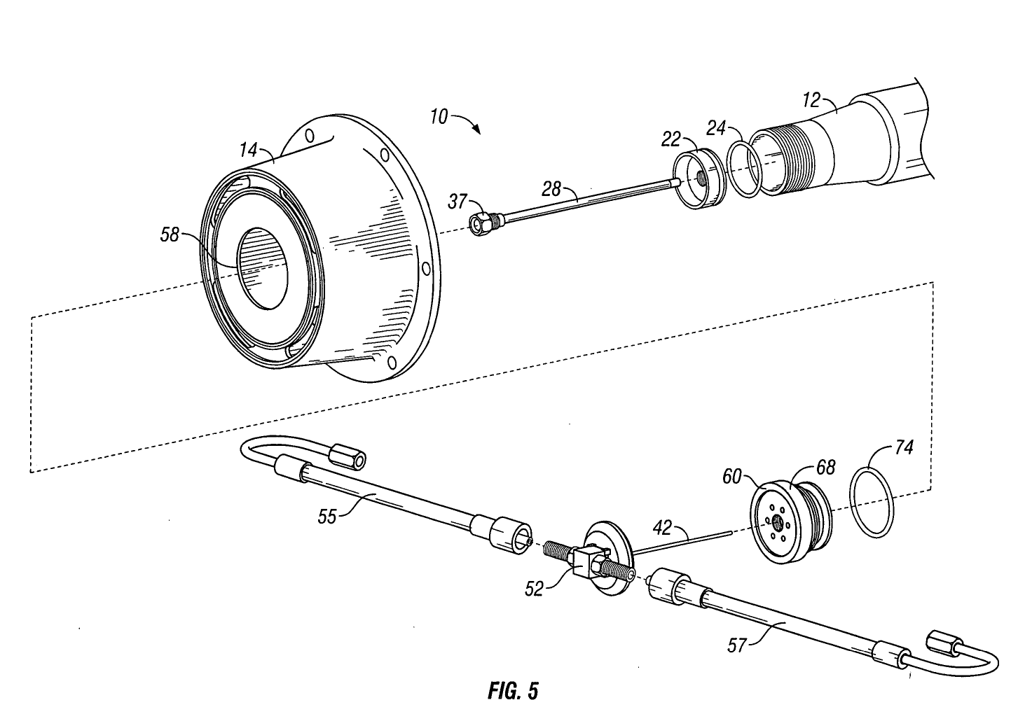

Referring now to FIGS. 2, 3, 4 and 5, the reference numeral 10 generally indicates the rotatable air connection of the present invention for supplying air from an air supply on a vehicle in an automatic tire inflation system for a vehicle to the rotating tires (not shown). The numeral 12 generally indicates one axle or spindle, a hubcap 14 is provided at each end of the axle 12 for retaining lubricant to the wheel bearings (not shown) and an air supply 16, either directly in the axle 12, or through an interior conduit (not shown) in the inside of the axle 12 for supplying air to the rotary connection through the inside of the axle. A pneumatic rotary union generally indicated by the reference numeral 20 is supported and positioned in the center of the axle 12, such as by force fit plug 22, but sealingly engages the interior of the axle 12 by a seal 24 if air is injected directly into the inside of the axle 12. The rotary union 20 has a first stationary part 28 threadably secured into the center of the plug 22 by threads 23, a passageway 36 therethrough and a hexagonal head 37. The passageway 36 is in communication with the air supply 16. A first resilient rotary seal 38 is supported in the passageway 36 and encircles the passageway 36. The union 20 includes a second rotatable part or rotor including a tubular member 42 having a first end 44 and a second end 46. The second end 46 is coaxially extendible through and is longitudinally and rotationally movable in the passageway 36 and sealably engages the rotary seal 38 and is in communication with the air supply 16. The first end 44 of the tubular member 42 is sealably connected to the air connection or through tee 52 on the hubcap 14 through a seal 50. The air connection 52 or through tee is provided on the hubcap 14 for connection to the tire or tires (not shown) at the end of the axle 12 through air hoses 55 and 57 (FIG. 5). The end 44 of the tubular member 42 includes a shoulder which includes a bearing 11. In operation, air 16 is supplied through the stationary part 28 of the rotary union 20. The inflation system 10 includes any suitable warning system such as a flow switch 32 and a warning indicator light 34 for indicating when the air pressure is leaking. The above description is generally disclosed in U.S. patent application Ser. No. 10/186,951 entitled “Rotary Air Coupling Connection with Bearing for Tire Inflation System,” which is herewith incorporated by reference.

In the present invention the hubcap 14 includes an opening 58 (FIG. 5) coaxially aligned with the rotary union 20. A plug 60 is releasably supported in the opening 68 and said plug includes a threaded support opening 62 coaxially aligned with the rotary union 20. The plug 60 includes one or more air vents 64, here shown as six, positioned outside of the support opening 62. The support opening 62 supports the through tee 52 in the opening 62 and in turn supports one end of the rotatable part 42 of the rotary union 20 and a vent shield 66 covering the outside of the air vents 64. The hubcap opening 58 is of a size for adding and visually inspecting lubrication level in the inside of the hubcap 14 and for passing a socket wrench for engaging the head 37 of the stator member 28 for removing the stator member 28 through the hubcap opening 58 without removing the hubcap 14. For example only, the opening 58 may be 1.625 inches in diameter. The plug 60 consists of a rigid material for providing a firm support for the through tee 52 and for example only may consists of a hard plastic such as Delrin. The plug 60 includes a head 68 at a first end for abutting the outside of the hubcap 14 and an extension 70 extending through and beyond the inside of the hubcap 14 and terminating in a second end 72. A circular seal 74 surrounds the plug 60 intermediate the first end 68 and the second end 72 and seals against the inside of the hubcap 14 and releasably holds the plug in position in the hubcap opening. However, the plug 60 may be easily removed from the opening 58 and a knurled surface is provided on the head 68 for that purpose. In addition, the plug 60 may be blown out the opening 58 in the event the air vents fail to exhaust the air. And if the plug 60 is blown out of opening 58 it will not be lost on the highway as occurs with conventional vent plugs since it is secured to lines 55 and 57 by the through tee 52.

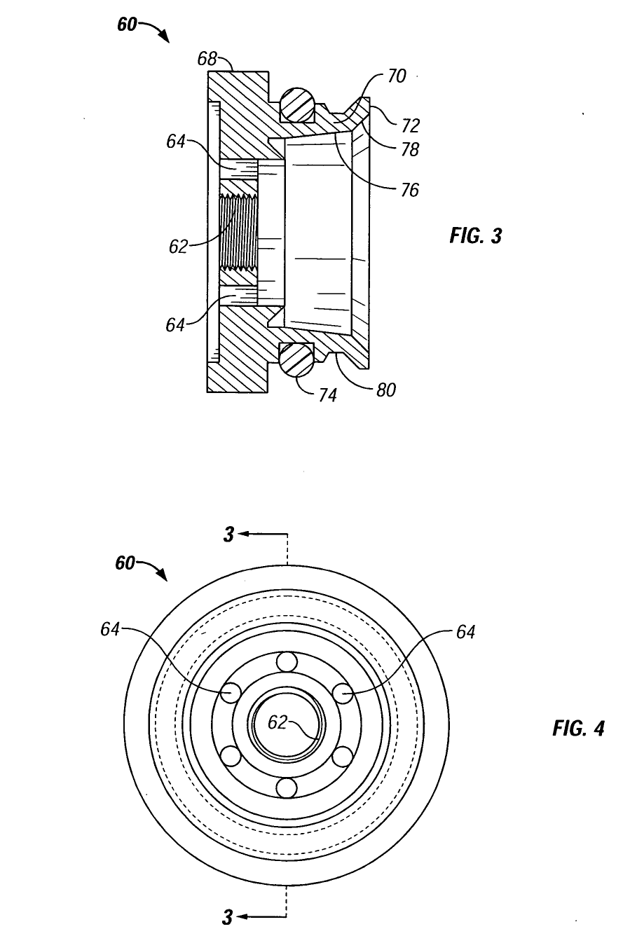

As best seen in FIG. 3, the plug 60 includes an extension 70 and surfaces exposed to the interior of the hubcap 14 which are positioned to direct lubrication in the hubcap away from the air vents 64 so that if oil passes through vent holes 64 of the plug 60 it may be centrifugally ejected onto the face of the hubcap 14. Also in the event of a leak in the air pressure system less of the lubricant may be blown out of the hubcap 14. The surfaces include an interior surface 76 outside of the air vents 64 and the interior surface 76 taper outwardly towards the second end 72 of the plug 60 for centrifugally directing lubrication away from the air vent 64 when the hubcap is rotating. The interior surface 76 may include a second outwardly directed tapered surface 78.

In addition, the plug 60 includes an exterior surface 80 adjacent the second end 72 of the plug 60 which includes a recess surrounding the exterior surface for directing lubrication away from the air vent 64 while the hubcap is static. For example, the overall length of the plug 60 may be one inch and the diameter of the head may be two inches. The taper 78 may be greater than the taper 76 and by way of example may be 45°.

Referring now to FIG. 5, the combination of the through tee fitting 52 and plug 60 may be popped out or manually removed from the opening 58 without disconnecting the air hoses 55 and 57. Lubricant on the interior of the hubcap 14 may be replaced and visually observed. If desired, the plug 60 may be unscrewed from the through tee fitting 52, the lines 55 and 57 removed, and the rotor 42 repaired. Additionally, stator 28 may be threadably removed from the plug 22. Thus, all of the wear parts in the rotary union 52 may be inspected, repaired and replaced without removing the hubcap 14. Thus, a minimum of tools, a minimum of expertise, and a minimum of time and expense are required to perform minor repairs on the wear portions of the system 10 of the present invention.

Although the present invention and its advantages have been described in detail, it should be understood that various changes, substitutions and alterations can be made herein without departing from the invention as defined by the appended claims. Moreover, the scope of the present application is not intended to be limited to the particular embodiments of the process, machine, manufacture, composition of matter, means, methods and steps described in the specification. As one will readily appreciate from the disclosure, processes, machines, manufacture, compositions of matter, means, methods, or steps, presently existing or later to be developed that perform substantially the same function or achieve substantially the same result as the corresponding embodiments described herein may be utilized. Accordingly, the appended claims are intended to include within their scope such processes, machines, manufacture, compositions of matter, means, methods, or steps.

1. An air inflation system having at least one axle with at least one wheel having a pneumatic tire at each end of the axle and a wheel end assembly connected to each end of the axle and including a hubcap forming a compartment for retaining lubricant for the wheel bearings, said vehicle having an air supply for supplying air to the inside of the axle, a pneumatic rotary union, having a first stationary part and a second rotatable part, in communication between the air inside the axle and the tire, and coaxially aligned with the axle comprising,
said hubcap having an opening coaxially aligned with the rotary union,
a plug releasably supported in the opening including a support opening axially aligned with the rotary union, said plug including one or more air vents positioned outside of the support opening, and said support opening supporting a through tee in communication with the air supply, a vent shield covering the outside of the air vents, and one end of the rotatable part of the rotary union,
said hubcap opening being of a size for adding and visually inspecting lubrication level and for removing the stationary part of the rotary union through the hubcap opening without removing the hubcap.

2. The apparatus of claim 1 wherein the plug consists of a rigid material for providing a firm support for the through tee, and said plug includes a head at one end for abutting the outside of the hubcap and an extension extending through and beyond the inside of the hubcap opening and terminating in a second end spaced from the hubcap for diverting lubricate away from the air vents, and
a circular seal surrounds the plug intermediate the first and second ends sealing against the inside of the hubcap and releasably holding the plug in position in the hubcap opening.

3. The apparatus of claim 2 wherein the plug includes surfaces exposed to the interior of the hubcap and the surfaces are positioned to direct lubrication in the hubcap away from the air vents.

4. The apparatus of claim 3 wherein the surfaces include an interior surface outside of the air vents, said interior surfaces tapering outwardly toward the second end of the plug for centrifugally directing lubrication away from the air vents when the hubcap is rotating.

5. The apparatus of claim 4 wherein the interior surface includes a first and a second outwardly directed tapered surface.

6. The apparatus of claim 3 wherein the plug includes an exterior surface adjacent the second end of the plug which includes a recess around the exterior surface for directing lubrication away from the air vents while the hubcap is static.

7. The apparatus of claim 2 wherein the outside of the head of the plug includes a knurled surface for ease of removing the plug from the hubcap opening.
